(19) United States
(12) Patent Application Publication
(10) Pub. No.: US 2010/0066656 A1
(43) Pub. Date: Mar. 18, 2010

(54) LIQUID CRYSTAL DISPLAY PANEL AND METHOD OF SCANNING SUCH LIQUID CRYSTAL DISPLAY PANEL

(75) Inventor: YUNG-SHUN YANG, Tainan County (TW)

Correspondence Address: LOWE HAUPTMAN HAM & BERNER, LLP, 1700 DIAGONAL ROAD, SUITE 300, ALEXANDRIA, VA, 22314, US

(73) Assignee: CHI MEI OPTOELECTRONICS CORP., Tainan County (TW)

(21) Appl. No.: 12/466,540

(22) Filed: May 15, 2009

(30) Foreign Application Priority Data
Sep. 15, 2008 (TW) 97135338

(51) Int. Cl. G09G 3/36; G02F 1/136

(52) U.S. Cl. 345/92; 349/42; 349/38

(57) ABSTRACT

A flat panel needs a reduced number of gate drivers and/or their pins by using two spaced scan lines to drive pixel units together. In the panel, additional capacitors are disposed on the scan lines and/or the scanning waveform of the scan signal is changed so as to reduce the influence of the scan signal on the pixel voltage. Alternatively or additional, such panel has control lines for indirectly supplying scan signals to the scan lines.

This application claims the benefit of Taiwan application Serial No. 97135338, filed Sep. 15, 2008, the entire disclosure of which is incorporated herein by reference.

### BACKGROUND

1. Technical Field

The disclosure generally relates to a liquid crystal display (LCD) panel of a pixel level multiplexing (PLM) architecture and, in particular, to an LCD panel and a method of scanning such LCD using a reduced number of scanning signals and/or required gate drivers and/or required gate drivers' pins.

2. Related Art

Recently, various flat panel displays (FPDs) emerge, such as liquid crystal displays (LCD), organic electro-luminescence devices (OLED), and plasma display panels (PDP). The architectures of such display panels are similar to one another, that is, scan lines and data lines are disposed on a substrate in an interlaced manner, and a pixel is disposed at every junction of the scan lines and the data lines. The pixel is determined to be enabled or selected or turned on according to a scan signal received by the respective scan line. When the pixel is turned on, the respective data line receives a data signal to display an image.

A higher resolution of the LCD panel requires more gate drivers. Each scan line requires a corresponding pad to be disposed for being connected to a pin of a gate driver, and thus not only a considerable layout area is needed, but an additional manufacturing cost is also required. Therefore, how to reduce the number the gate driver ICs (integrated circuits) and/or the number of their pins, while maintaining the same resolution is one of the important development directions of the known LCD panel driving technology.

FIG. 1 is a schematic partial circuit diagram of an LCD panel. A local circuit 100 in the LCD panel includes a plurality of data lines (such as DL₁, DL₂) and N scan lines (such as SEᵢ and SOᵢ), in which i and N are positive integers, i is an index of the scan lines, and 0<i≦N/2. The odd scan line SOᵢ corresponds to an odd pixel row 110, the even scan line SEᵢ corresponds to an even pixel row 120. The even pixel row 120 and the odd pixel row 110 each includes a plurality of pixel units (such as 111, 112, 121, and 122). Each pixel unit includes components such as a transistor, a liquid crystal capacitor, and a storage capacitor. Each transistor includes components such as a drain, a source and a gate. The pixel units can adopt a known pixel structure, and the pixel units (such as 111, 112, 121, and 122) in FIG. 1 are illustrated for exemplification.

Take the even pixel row 120 and the odd pixel row 110 as examples, the even pixel row 120 is coupled to the even scan line SEᵢ, the odd pixel row 110 is coupled to the odd scan line SOᵢ. The other end of the odd scan line SOᵢ is coupled to an end of a transistor M1, the other end of the transistor M1 is coupled to a next even scan line SEᵢ₊₁, and a gate of the transistor M1 is coupled to the even scan line SEᵢ. When the even scan lines SEᵢ and SEᵢ₊₁ are enabled (i.e., at a logic high level), the odd pixel row 110 and the even pixel row 120 are turned on, such that the data lines (such as DL₁, DL₂) write the pixel data to the corresponding pixel units (such as 111, 112 of the pixel row 110). Then, when only the even scan line SEᵢ is enabled, the odd pixel row 110 is turned off, and only the even pixel row 120 is turned on, such that the data lines (such as DL₁, DL₂) write the pixel data into the pixel units (such as 121, 122 of the pixel row 120) to update the pixel voltage in the pixel row 120. The circuit structures of the remaining odd scan lines, even scan lines, and the corresponding pixel units may be deduced by analogy, and will not be repeated herein. Further, it should be noted that, transistors M1, M2 in FIG. 1 are thin film transistor (TFT) and can be positioned in a fan-out area 150 or a non-active area (not shown) of the LCD panel.

The waveforms of the scan signals (i.e., the scan signal that should be outputted by the gate driver) received by the odd scan line SEᵢ and the even scan line SEᵢ₊₁ are shown in FIG. 2. During a first half period of a second period T2, the even scan lines SEᵢ and SEᵢ₊₁ are enabled, and at this time, the odd pixel row 110 and the pixel row 120 are turned on. Then, during a second half period of the second period T2, the even scan line SEᵢ is maintained to be enabled, while the even scan line SEᵢ₊₁ is disabled, and at this time, only the pixel row 120 is turned on. By such timing, the pixel data in the odd pixel row 110 and the even pixel row 120 can be updated in sequence.

Next, the even scan line SEᵢ₊₁ is enabled during a third period T3 to update the corresponding odd pixel row and even pixel row. During a first period T1, the even scan line SEᵢ is enabled during a first half period of the first period T1 together with a scan signal of an even scan line SEᵢ₋₁ (not shown), so as to update the odd pixel row of the corresponding odd scan line SOᵢ₋₁ (not shown) similar to the manner in which the even scan line SEᵢ₊₁ is enabled during the first half period of the second period T2 together with the even scan line SEᵢ. It should be noted that, the first period T1, the second period T2, and the third period T3 have the same duration, and the scan signals of the remaining scan lines can be deduced by analogy, such that the pixels of the whole panel are updated. By using the panel architecture of FIG. 1, only a half number, i.e., N/2, of the scan signals are required to drive all the pixel units, thus reducing the number of the gate driver ICs and/or their pins.

During the scanning process discussed above, the pixel units are affected by a voltage variance of the scan signal, that is, due to the so-called feed through effect. During the second period T2, the even pixel row 120 is affected only by the feed through effect caused by a falling edge 201 of the scan signal of the even scan line SEᵢ, and the odd pixel row 110 is affected by the feed through effect caused by the falling edge 201 of the scan signal of the even scan line SEᵢ and a falling edge 202 of the scan signal of the next even scan line SEᵢ₊₁. Therefore, during the scanning process, the feed through effect on the odd pixel row 110 is greater than that on the even pixel row 120. If the whole image has the same grey level, non-uniform image quality will occur due to the different feed through effects.

FIG. 3 is an equivalent partial circuit diagram of the LCD panel in FIG. 1. The pixel unit 11 includes a transistor M111, a liquid crystal capacitor Clc2, a storage capacitor Cst2, and a capacitor Cgs2 represented as a gate-source equivalent capacitance of the transistor M111. A capacitor Cgsf in the fan-out area 150 represents a gate-source equivalent capacitance of the transistor M1. The circuit structure of the pixel unit 121 is the same as that of the pixel unit 111, and will not be repeated herein. Referring to the equivalent circuit diagram in FIG. 3 and the signal waveform diagram in FIG. 2, the influence on pixel voltages of the pixel units 111 and 121 (i.e., the pixel voltages stored on the liquid crystal capacitors Clc2 and Clc1) of a voltage variance (from high voltage Vgh to low voltage Vgl) of the scan signal can be calculated.

During the second period T2, the pixel voltage on the pixel unit 121 is affected only by the falling edge 201 of the even scan line SEᵢ (referring to FIG. 2), that is, the voltage drop caused by the capacitor Cgs1, and the feed through voltage Δ V1 can be represented as:

$$Δ V 1 = ( Vgh - Vgl ) \times \frac{Cgs 1}{Cgs 1 + Clc 1 + Cst 1} . \qquad ( 1 )$$

Cgs1, Clc1, and Cst1 in formula (1) represent the corresponding equivalent capacitance of pixel unit 121.

The pixel unit 111 is affected by the falling edge 201 of the scan signal of the even scan line SEᵢ and the falling edge 202 of the scan signal of the SEᵢ₊₁, and the feed through voltage ΔV2 can be represented as:

$$Δ V 2 = ( Vgh - Vgl ) \times \frac{Cgs 2}{Cgs 2 + Clc 2 + Cst 2} \times ( 1 + \frac{Cgsf}{Cgsf + n \times CX} ) \qquad ( 2 )$$

In Formula (2), n represents the number of the pixel units in the even pixel row 120, and CX represents the value of the Cgs2 connected to the (Clc2+Cst2) in series.

It can be seen from Formulas (1) and (2), the feed through voltage ΔV2 of the pixel unit 111 caused by the scan signal is greater than the feed through voltage ΔV1 of the pixel unit 121 caused by the scan signal. Therefore, during the scanning process, the pixel voltages on the pixel unit 111 and the pixel unit 121 have different voltage variances due to the scan signal, which affects the display quality and stability.

Further, when the even scan line SEᵢ is disabled, the odd scan line SOᵢ is in a floating state. Many circuit lines or capacitors around the gate of the transistor M111 may result in that the gate voltage of the transistor M111 shifts to a common voltage Vcom due to the electrical coupling effect, thus affecting the pixel voltage on the liquid crystal capacitor Clc2.

### BRIEF DESCRIPTION OF THE DRAWINGS

One or more embodiments are illustrated by way of example, and not by limitation, in the figures of the accompanying drawings, wherein elements having the same reference numeral designations represent like elements throughout.

FIG. 1 is a schematic partial circuit diagram of an LCD panel.

FIG. 2 is a scanning signal waveform diagram of FIG. 1.

FIG. 3 is an equivalent partial circuit diagram of the LCD panel in FIG. 1.

FIG. 4 is a partial circuit diagram of an LCD panel according to a first embodiment.

FIG. 5 is a structural view of a capacitor Cst according to the first embodiment.

FIG. 6 is a scan signal waveform diagram according to a second embodiment.

FIG. 7 is a partial circuit diagram of an LCD panel according to a third embodiment.

FIG. 8 is a scan signal waveform diagram of FIG. 7.

### DETAILED DESCRIPTION OF EMBODIMENTS

One or more embodiments provide a flat panel, such as an LCD panel, which uses two spaced scan lines to drive pixel units together to reduce the number of gate drivers (pins) required by the panel. Such panel has additional capacitors disposed on the scan lines and/or has the scanning waveform of the scan signal changed, so as to reduce the influence of the scan signal on the pixel voltage. Alternatively or additional, such panel has control lines for indirectly supplying scan signals to the scan lines.

### First Embodiment

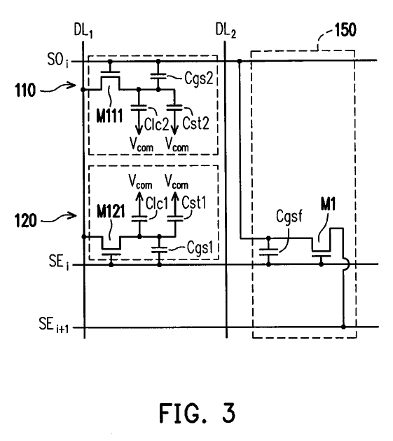

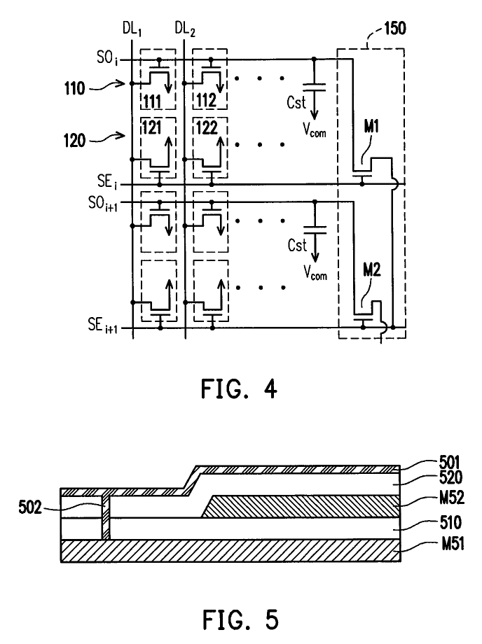

FIG. 4 is a partial circuit diagram of an LCD panel according to a first embodiment. In order to reduce the feed through voltage ΔV2 of a pixel unit 111 as discussed above with respect to FIGS. 1-3, in this embodiment, a capacitor Cst is connected to an odd scan line SOᵢ. The capacitor Cst and the pixel unit 111 on the odd scan line SOᵢ are connected in parallel to increase the capacitance. Referring to Formula (2), when the capacitor Cst is taken into account, (Cgs+n×CX) in Formula (2) becomes (Cgs+n×CX+Cst), that is, the value thereof is increased, and thus the feed through voltage ΔV2 is reduced to approach the feed through voltage ΔV1. As the capacitor Cst is connected to all the pixel units (such as, 111, 112) on the odd scan line SOᵢ in parallel, the capacitor Cst has the efficacy of reducing the feed through voltage of other pixel units (such as, 112) on the odd scan line SOᵢ as well.

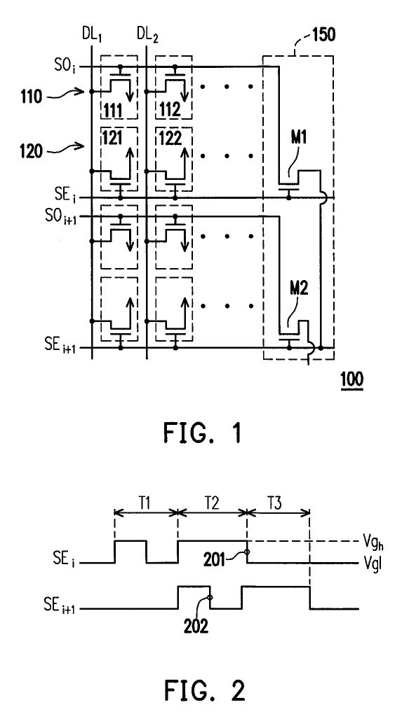

In this embodiment, similarly, other odd scan lines (such as, SOᵢ₊₁) each also has a capacitor Cst connected thereto to reduce the influence of the scan signal thereon. The other end of the capacitor Cst is coupled to a common voltage terminal Vcom or a ground terminal, and therefore the equivalent capacitance on each odd scan line SOᵢ is increased. The remaining circuits of the LCD panel in FIG. 4 and the operation thereof are similar to those described in FIGS. 1 and 2, and will not be repeated herein. Further, due to the increased capacitance provided by capacitor Cst, the odd scan lines will not be easily affected by other circuits, and the voltage thereof will not be easily changed.

The capacitor Cst should have a capacitance great enough to affect all the pixel units on the respective odd scan line SOᵢ. Generally, a greater capacitance is obtained by a large area. Therefore, in an embodiment, the capacitor Cst has a sandwich-like layered structure to obtain a large enough area. Several capacitors Cst in some embodiments are distributed along the respective scan line to achieve the required capacitance.

FIG. 5 is a structural view of the capacitor Cst according to an embodiment. Referring to FIG. 5, a first metal layer M51 and a second metal layer M52 are two ends of the capacitor Cst, a transparent electrode ITO 501 is located at the other side of the second metal layer M52, and is connected to the first metal layer M51 through a via 502. The transparent electrode ITO 501 functions as an electrode of Cst to increase its capacitance. As the second metal layer M52 is located between the transparent electrode ITO 501 and the first metal layer M51, a large overlapped area is thus formed to form a large capacitance. In this specific embodiment, the second metal layer M52 is coupled to receive Vcom. A passivation film 520 is disposed between the transparent electrode ITO 501 and the second metal layer M52, and an insulation layer 510 is disposed between the first metal layer M51 and the second metal layer M52 to avoid electrical short-circuits between various electrode layers. In some embodiments, the passivation film 520 is made of, for example, SiO₂, and the insulation layer 510 is made of, for example, SiNₓ. The capacitor Cst is formed in one or more embodiments in the fan out area 150 and/or the active area. The structure of the capacitor Cst in FIG. 5 can generally be achieved through one or more known LCD panel manufacturing processes, which will not be described herein.

### Second Embodiment

In addition to eliminating the capacitance difference between the odd scan line SOᵢ and the even scan line SEᵢ by disposing the capacitor Cst, in the above described embodiment(s), a method for eliminating the difference between pulling voltages ΔV1 and ΔV2 by adjusting the scanning waveform of the scan signal is further provided.

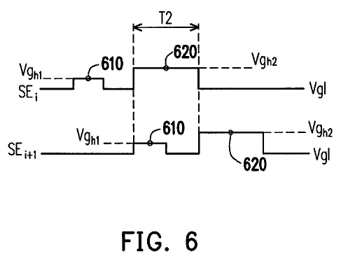

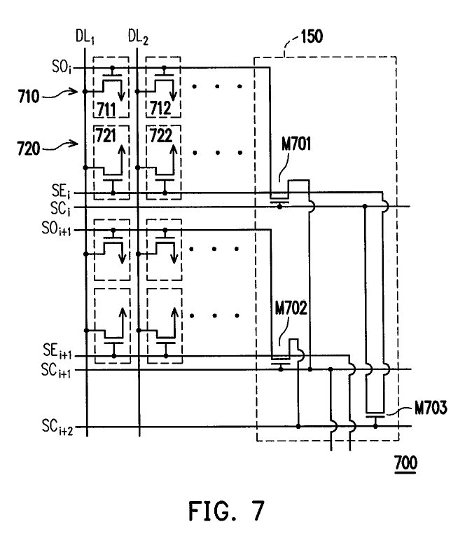

FIG. 6 is a scan signal waveform diagram according to a second embodiment, which is applicable for scanning the known LCD panel, e.g. the LCD panel in FIG. 1. Referring to FIGS. 6 and 1 together, during a second period T2, the voltage of an enable voltage 620 of an even scan line SEᵢ is made to be Vgh2, the voltage of an enable voltage 610 of an even scan line SEᵢ₊₁ is made to be Vgh1, and Vgh2 is greater than Vgh1. Vg1 is the voltage of the even scan line SEᵢ₊₁ or the even scan line SEᵢ when any one of the even scan lines is disabled (or referred to as a logic low level). Due to the change of the scan signal waveform of the even scan lines SEᵢ and SEᵢ₊₁, Formula (1) and Formula (2) can be modified to be Formula (3) and Formula (4) as follows, respectively:

$$\begin{matrix}Δ V 1 = ( Vgh 2 - Vgl ) \times \frac{Cgs 1}{Cgs 1 + Clc 1 + Cst 1} & ( 3 ) \\ Δ V 2 = ( Vgh 1 - Vgl ) \times \frac{Cgs 2}{Cgs 2 + Clc 2 + Cst 2} + ( Vgh 2 - Vgl ) \times ( \frac{Cgsf}{Cgsf + n \times CX} ) \times ( \frac{Cgs 2}{Cgs 2 + Clc 2 + Cst 2} ) & ( 4 )\end{matrix}$$

As shown in Formula (4), when the voltage Vgh1 is decreased, the pulling voltage ΔV1 on the pixel unit 121 and the pulling voltage ΔV2 on the pixel unit 111 approach to each other. During scanning the pixel units on the whole LCD panel, the scan signal is as shown by the even scan line SEᵢ and the even scan line SEᵢ₊₁ in FIG. 6, the scan signal has a delay time, also called as a scanning period, and the whole LCD panel is scanned by the same waveform in sequence. Specifically, except for the lower voltages Vgh1 at 610, the waveforms in FIG. 6 are similar to those in FIG. 2. According to the above description, a person of ordinary skill in the art would understand how the waveforms in FIG. 6 work with the known LCD structure of FIG. 1 and how the scan signal waveforms correspond to the remaining scan lines and as well as the timings thereof.

### Third Embodiment

FIG. 7 is a partial circuit diagram of an LCD panel according to a third embodiment. In FIG. 7, a local circuit 700 in the LCD panel includes a plurality of data lines (such as, DL₁ and DL₂), control lines SCᵢ, odd scan lines SOᵢ, and even scan lines SEᵢ, in which i is an index of the scan lines, and if the LCD panel includes N scan lines, 0<i≦N/2, and i and N are positive integers. Each control line corresponds to an odd scan line and an even scan line. For example, a control line SCᵢ corresponds to an odd scan line SOᵢ for scanning an odd pixel row 710 and an even scan line SEᵢ for scanning an even pixel row 720, in which the odd pixel row 710 and the even pixel row 720 each includes a plurality of pixel units (such as 711, 712, 721, and 722). The structure of each pixel unit has a liquid crystal capacitor, a storage capacitor (not shown), and a transistor, and various pixel structures, which can be adopted according to different demands, and the description of which will not be repeated herein.

A transistor M701 is coupled between the odd scan line SOᵢ and the control line SCᵢ₊₁, and a gate of the transistor M701 is coupled to a i^{th} control line SCᵢ. Similarly, a transistor M702 is coupled between the odd scan line SOᵢ₊₁ and the control line SCᵢ₊₂, and a gate of the transistor M702 is coupled to a (i+1)^{th} control line SCᵢ₊₁. A transistor M703 is coupled between the even scan line SEᵢ and an i^{th} control line SCᵢ, and a gate of the transistor M703 is coupled to a (i+2)^{th} control line SCᵢ₊₂. The connection relationship of the remaining odd, even scan lines and the corresponding control lines can be deduced by analogy, and thus will not be repeated herein.

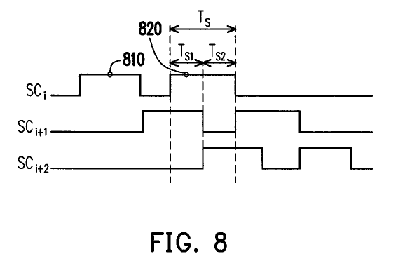

FIG. 8 is a scan signal waveform diagram of FIG. 7. The local circuit 700 in the LCD panel includes control lines SCᵢ, odd scan lines SOᵢ, and even scan lines SEᵢ. The control line SCᵢ is enabled during a scanning period Tₛ, and at this time, the transistor M701 is turned on, and a next control line SCᵢ₊₁ is enabled during a first half period T_{S1} of the scanning period Tₛ to turn on the odd scan line SOᵢ. Thereafter, a next control line SCᵢ₊₂ is enabled during a second half period T_{S2} of the scanning period Tₛ to turned on the transistor M703, so as to turn on the even scan line SEᵢ. Thus, during the scanning period Tₛ, the pixel data can be written into the pixel units (such as 711, 712, 721, and 722) on the odd pixel row 710 and the even pixel row 720 corresponding to the control line SCᵢ. The scanning manner of the remaining even and odd scan lines on the LCD panel can be deduced by analogy, and will not be repeated herein.

In this embodiment, pins of the gate driver(s) are each connected to one of the control lines so as the gate driver(s) can drive all the control lines to scan all the pixel units (i.e., correspondingly scanning all the odd and even scan lines), and the number of the control lines SCᵢ is only a half of that of all the scan lines (including the even and odd scan lines) in the LCD panel, thus the number of the gate drivers and/or their pins is reduced for scanning the whole LCD panel. Further, it should be noted that, the odd scan lines and the even scan lines in this description are used only to distinguish two adjacent scan lines, the disclosure is not limited thereto, and in other embodiments, the arrangement of the odd and even scan lines can be reversed.

Each control line SCᵢ does not directly turn on the pixel units, but works together with the next two control lines SCᵢ₊₁ and SCᵢ₊₂ to indirectly enable the corresponding odd scan line SOᵢ and the corresponding even scan line SEᵢ. Therefore, the scan signal on the control line SCᵢ has two pulses 810 and 820, in which the pulse 810 works together with the former two control lines SCᵢ₋₁ and SCᵢ₋₂ (not shown), and the pulse 820 turns on the odd pixel row 710 and the even pixel row 720 corresponding to the control line SCᵢ.

During the scanning process, as the scanning operation and the circuit structure of the odd pixel row 710 are identical to those of the even pixel row 720, the feed through effects on the pixel units (such as 711 and 721) are the same, that is, the influence on the pixel units 711 and 721 of the scan signal on the control lines SCᵢ, SCᵢ₊₁, and SCᵢ₊₂ are the same. The influence on the pixel voltage of the pixel units on the odd pixel row 710 and the even pixel row 720 due to the scanning operation are the same, and thus the display quality of images is stable. Further, in known LCDs, each pixel row requires a scan signal to drive, instead, in this embodiment, a half of the number, i.e., N/2, of the scan signals are used to drive all the pixel rows. By means of the technique of the embodiments, the number of the gate driver ICs and/or their pins are reduced.

Furthermore, the transistors M701-M703 are similar to the transistors M1 and M2 in FIG. 1, and can be formed in the fan-out area 150. Definitely, if the layout area of the LCD panel still has enough space, the transistors M701-M703 can also be disposed in an appropriate area according to the demands of the designer.

It should be noted that, in the disclosed embodiments, the notations of odd scan line SOᵢ and the even scan line SEᵢ are used only to describe the position relationship of the adjacent scan lines, and the disclosure will not be limited thereto. If the LCD panel has N scan lines, the odd scan line SOᵢ and the even scan line SEᵢ can also be represented by i^{th} scan line and (i+1)^{th} scan line, in which N and i are positive integers, and i is less than N, without changing the structures and principles of operation disclosed herein.

Thus, the influence on different pixel rows of the scan line signal is reduced by adding sufficiently large capacitors, and/or changing the waveforms of the scan signal, and/or directly adjusting the scanning operation and circuit according to the feed through effect. As a result, the problem of non-uniform image quality is solved, and the influence on the pixel voltage of the voltage variance of the scan signal is reduced.

The disclosed embodiments are also applicable to other types of FPDs, e.g., OLED and PDP.

What is claimed is:

1. A flat panel for a flat panel display, said panel comprising
N scan lines and N pixel rows corresponding to the N scan lines, respectively, wherein N is a positive integer, and
for each set of i^{th}, (i+1)^{th} and (i+3)^{th} scan lines, wherein i is a positive integer less than or equal to N−3:
a transistor comprising first and second terminals coupled to the i^{th} scan line and the (i+3)^{th} scan line respectively, and a gate coupled to the (i+1)^{th} scan line; and
a capacitor coupled between the i^{th} scan line and a common terminal.

2. The panel according to claim 1, wherein the capacitor has a sufficiently large capacitance for minimizing a difference in feed through effect voltage between the i^{th} pixel row and the (i+1)^{th} pixel row, said difference in feed through effect voltage being caused by an equivalent capacitance of the transistor between the first terminal and the gate terminal.

3. The panel according to claim 1, wherein the common terminal is a ground terminal or a common voltage terminal, the first terminal is a source and the second terminal is a drain of the transistor.

4. The panel according to claim 1, wherein the capacitor comprises:
a first metal layer;
an insulation layer, formed on the first metal layer;
a second metal layer, formed on the first metal layer;
a passivation film, formed on the second metal layer;
a transparent electrode, formed on the passivation film; and
at least one conductive via extending through at least one of the insulation layer and the passivation film to electrically connect the first metal layer and the transparent electrode.

5. The panel according to claim 1, further comprising a gate driver for supplying a first scan signal to the (i+1)^{th} scan line and a second scan signal to the (i+3)^{th} scan line,
wherein
during a predetermined scan period, the first scan signal is enabled, and the second scan signal is enabled during a first half of the predetermined scan period and is disabled during a second, subsequent half of the predetermined scan period.

6. The panel according to claim 5, wherein
during a preceding scan period immediately prior to the predetermined scan period, the second scan signal is disabled, and the first scan signal is enabled during a first half of the preceding scan period and is disabled during a second, subsequent half of the preceding scan period; and
during a next scan period immediately after the predetermined scan period, the first scan signal is disabled, and the second scan signal is enabled.

7. The panel according to claim 1, wherein the transistor is formed in a fan-out area of the panel.

8. A method of scanning pixels of a flat panel for a flat panel display, said panel comprising
N scan lines and N pixel rows corresponding to the N scan lines, respectively, wherein N is a positive integer, and
for each set of i^{th}, (i+1)^{th} and (i+3)^{th} scan lines, wherein i is a positive integer less than or equal to N−3, a transistor comprising first and second terminals coupled to the i^{th} scan line and the (i+3)^{th} scan line respectively, and a gate coupled to the (i+1)^{th} scan line;
said method comprising supplying a first scan signal to the (i+1)^{th} scan line and a second scan signal to the (i+3)^{th} scan line, wherein
during a predetermined scan period, the first scan signal is enabled with a first enable voltage, and the second scan signal is enabled during a first half of the predetermined period with a second enable voltage and is disabled during a second, subsequent half of the predetermined scan period, wherein the first enable voltage of the first scan signal is greater than the second enable voltage of the second scan signal.

9. The method according to claim 8, wherein during a next scan period, the second scan signal is enabled with he first enable voltage.

10. The method according to claim 8, wherein
during a preceding scan period immediately prior to the predetermined scan period, the second scan signal is disabled, and the first scan signal is enabled during a first half of the preceding scan period with the second enable voltage and is disabled during a second, subsequent half of the preceding scan period.

11. The method according to claim 8, wherein the scan periods are equal in length.

12. The method according to claim 8, wherein the second enable voltage is selected so as to minimize a difference in feed through effect voltage between the i^{th} pixel row and the (i+1)^{th} pixel row, said difference in feed through effect voltage being caused by an equivalent capacitance of the transistor between the first terminal and the gate terminal.

13. A flat panel for a flat panel display, said panel comprising
N scan lines and N pixel rows, corresponding to the N scan lines, respectively, wherein N is a positive integer, and
for each set of i^{th} through (i+5)^{th} scan lines, wherein i is a positive integer less than or equal to N−5:
a first control line corresponding to the i^{th} scan line and the (i+1)^{th} scan line,;
a second control line, corresponding to the (i+2)^{th} scan line and the (i+3)^{th} scan line;
a third control line, corresponding to the (i+4)^{th} scan line and the (i+5)^{th} scan line;
a first transistor comprising a first drain and a first source coupled to the i^{th} scan line and the second control line respectively, and a first gate coupled to the first control line; and
a second transistor comprising a second drain and a second source coupled to the (i+1)^{th} scan line and the first control line respectively, and a second gate coupled to the third control line.

14. The panel according to claim 13, further comprising a gate driver coupled to the control lines for indirectly supplying scan signals to the scan lines via the respective control lines and transistors.

15. The panel according to claim 14, wherein during a scanning period of the first control line, the first control line is enabled, the second control line is enabled during a first half of the scanning period of the first control line, and the third control line is enabled during a second half of the scanning period of the first control line.

16. The panel according to claim 15, wherein the second control line is disabled during the second half of the scanning period of the first control line, and the third control line is disabled during the first half of the scanning period of the first control line.

17. The panel according to claim 13, wherein the first and second transistors are formed in a fan-out area of the panel.

18. The panel according to claim 13, wherein the first and second transistors are thin film transistors (TFT).

19. The panel according to claim 1, wherein the transistor is a thin film transistor (TFT).
